(19) United States
(12) Patent Application Publication
(10) Pub. No.: US 2006/0201297 A1
(43) Pub. Date: Sep. 14, 2006

(54) Powered feed system for use with a machine saw table for providing guided motion along at least one axis

(76) Inventor: Gary Friend, Commerce Township, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/075,908

(22) Filed: Mar. 9, 2005

(51) Int. Cl. B26D 7/06

(52) U.S. Cl. 83/436.1; 83/448

(57) ABSTRACT

A system for advancing a workpiece in guided fashion towards a rotating blade associated with a saw or router table, the table including a fence securing a distance from the blade. A three-dimensional and elongated housing is secured upon the table, the saw being disposed between the housing and fence. The unit is laterally adjustable upon the table in directions towards and away from the blade, a width dimension associated with the workpiece generally corresponding to a distance between the housing and fence. A plurality of unidirectional rollers are incorporated into the housing, each of the rollers securing at linearly spaced intervals along the housing and each exhibiting a shaft supported and vertical axis of rotation, such that an outer radial edge associated with each roller contacts an associated side edge of the workpiece. The unidirectional rollers facilitate linear feed of the workpiece against the blade, the housing and fence preventing kick-back of the workpiece resulting from a ripping operation performed by the blade.

### BACKGROUND OF THE INVENTION

1. Field of the Invention

The present invention is directed generally to machine feed and control devices, such as in use with a rotary saw table. More specifically, the present invention discloses a powered feed assembly for use with a machine saw or router table and which provides guided motion of a linearly fed workpiece along at least one axis.

2. Description of the Prior Art

The prior art is well documented with examples of workpiece feed, support or hold down devices incorporating some type of roller or wheel support. A first example of this is set forth in U.S. Pat. No. 4,976,298, issued to Gibson, and which teaches an anti-kickback hold down device having provision for mounting on and removal from a saw availed of for ripping material, primarily wood. The device includes a spring pressed wheel to engage the material being ripped, thus enabling ripping (sawing) wood of widely varying thickness, and preventing reverse movement of the wood caused by the saw itself. Ratchet elements control the wheel operation which are able to be positioned in varied longitudinal alignment, as well as to release or disable the ratchet at will. Axial alignment of the wheel provides for holding the material being ripped, against a fence or like guide during the ripping operation.

U.S. Pat. No. 4,469,318, issued to Slavic, teaches a device for holding a workpiece against a table while urging it against a guide fence when the workpiece is being operated on by a table saw or the like having a pair of wheels rotatably mounted on a plate member supported on the end of first and second arms. The other ends of the arms are held by a frame member, with a spring member extending from one upper arm to the opposite lower arm. The arms form a parallelogram and are rotatably mounted to apply force to pressure the wheels against the table, the frame being at an angle to the guide fence so that the wheels are at an angle towards the fence in the direction of the movement of the workpiece.

U.S. Pat. No. 5,148,846, issued to Van Gelder, teaches a workpiece guide to help feed boards into a woodworking machine such as a power saw. The guide is adapted to hold the board against the guide fence as the board is fed into the saw by pressing a knurled wheel down against the board. The wheel is slightly angled to move the board toward the fence and is pressed down against the board by a leaf spring thus keeping the board from riding up on the blade.

U.S. Pat. No. 5,058,474, issued to Herrera, teaches a height adjustment means for biasing a wheel and for safely controlling a workpiece disposed on the deck of a machine tool by urging it toward a stationary frame. The height of the elongated arm and bias wheel is easily controlled by a minutely adjustable cam mechanism, which is movable against a preset spring tension.

U.S. Pat. No. 3,738,403, issued to Schwoch, teaches a board-engaging device for saws and the like designed to laterally urge boards toward a fence or guide during ripping and similar operations where it is necessary that each board move in a straight path for accuracy. Inclined rolls at opposite sides of the rotating tool element frictionally grip the board and hold it toward a stationary guide or fence. The rolls are vertically movable, being biased toward a work table by springs or other similar biasing devices. They can be pivoted on an attachment assembly selectively mounted to the table surface of the tool, or can be alternatively mounted in a permanent fashion directly upon the table.

U.S. Pat. No. 5,228,374, issued to Santeramo, teaches a table saw fence assembly wherein a fence element is connected in a “T” arrangement across the end of a slide blade which is reciprocal linearly between guide wheels on a base affixed to the top of a saw table, preferably directly above the saw blade axis when the blade axis is horizontal.

U.S. Pat. No. 4,603,612 teaches a safety attachment for a table saw, the attachment including a body which rests on the rip rail of the saw and which is guided slidably along the rail by two depending legs and by two pivoted arms. The leading end of one of the legs engages the trailing end of the board to push the board into and past the saw blade while the lower end of one of the arms presses the board downwardly against the table to prevent the board from flying upwardly. The hold-down arm is spring-biased into pressing engagement with the board and may swing upwardly and downwardly to accommodate boards of different thicknesses.

U.S. Pat. No. 5,918,520, issued to Whitcomb, teaches a straight line saw guide including a base slidable along a table saw. A movable top is slightly situated on a top face of the base and further adapted to be fixed with respect thereto. The movable top is adapted to move in a direction perpendicular with respect to the movement of the base. Further, the movable top serves to abut a piece of wood situated on the base. Finally, at least one clamp assembly is included for maintaining the piece of wood fixed with respect to the base and movable top.

### SUMMARY OF THE PRESENT INVENTION

The present invention discloses a system for advancing a workpiece in guided fashion, and typically along at least one axial direction, towards a rotating blade associated with a saw table. The saw table typically includes a fence securing a distance from the blade.

The system includes a three-dimensional and elongated housing secured upon the table, the saw blade being disposed between the housing and fence. The unit is laterally adjustable upon the table in directions towards and away from the blade.

A width dimension associated with the workpiece, typically a length of lumber, generally corresponds to a distance between the housing and fence. A plurality of unidirectional rollers are incorporated into the housing, each of the rollers securing at linearly spaced intervals along the housing and each exhibiting a shaft supported and vertical axis of rotation.

Outer radial edges associated with each of the shaft supported rollers, these typically each including a heavy-duty rubberized material, contact an associated side edge of the workpiece. The unidirectional rollers facilitate linear feed of the workpiece against the blade, the housing and fence operating together to prevent kick-back of the workpiece resulting from a ripping operation performed by the blade.

Additional features include the provision of at least one hold-down attachment secured to the housing and supporting a roller for contacting an upper edge surface of the linearly fed workpiece. Also, a motorized sub-assembly can be secured to the housing, and which is capable of driving one or more (typically a pair) of the unidirectional rollers such as located on a feed side of the rotary blade and in order to provide powered feed of the workpiece against the saw during its ripping operation.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an environmental perspective of the feed and hold-down system and illustrating a laterally adjustable module incorporating a plurality of unidirectional feed and hold rollers, in cooperation with a likewise laterally adjustable fence assembly held down by a cam actuated handle;

FIG. 2 is a cutaway view taken along line 2-2 of FIG. 1 and illustrating the arrangement of a selected roller;

FIG. 3 is an exploded view of a roller sub-assembly such as shown in FIG. 2 and further illustrating the features of a clutch (with inner and outer annular race components), shaft, coil spring and key ring for accomplishing unidirectional movement;

FIG. 4 is an overhead view of a linear feed operation further incorporating a motor driven sub-assembly secured to the hold-down module and operatively engaging one or more of its associated rollers;

FIG. 5 is a perspective illustration of the motor driven sub-assembly according to the present invention; and

FIG. 6 is a cutaway illustration of the motor driven sub-assembly of FIG. 5 and further showing a preferred spur gear drive arrangement for providing powered operation of associated unidirectional rollers.

### DETAILED DESCRIPTION OF THE PREFERRED EMBODIMENTS

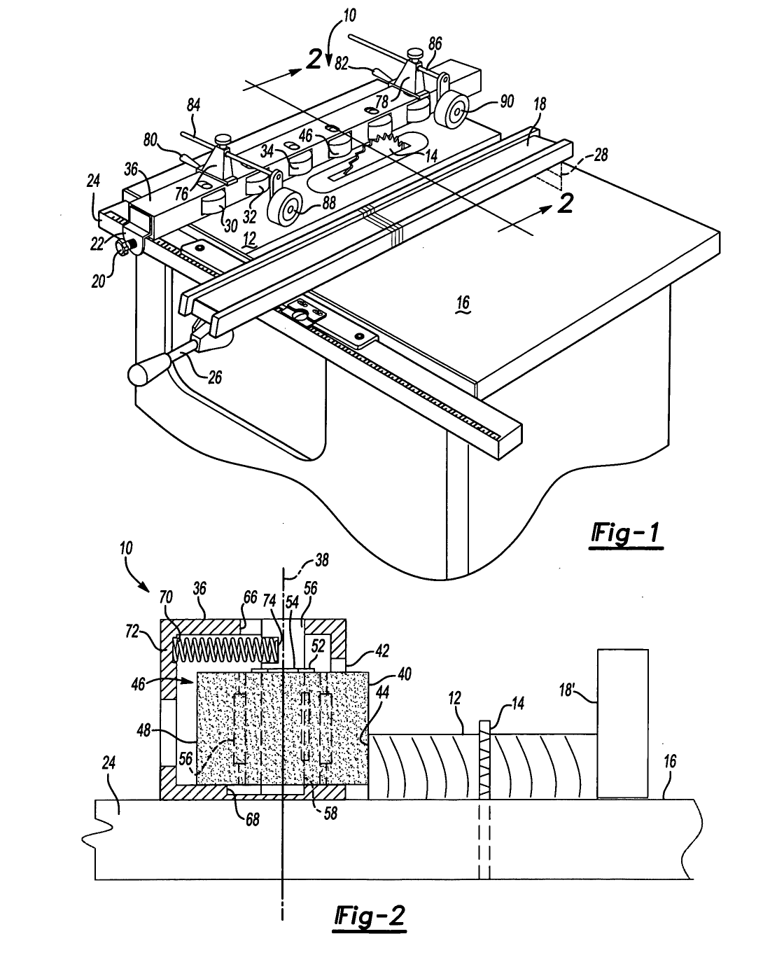

Referring to FIG. 1, an illustration is generally shown at 10 of a unidirectional feed system associated with a conventional saw or router table and according to a preferred embodiment of the present invention. The feed system 10 facilitates unidirectional movement of an associated workpiece, see as referenced at 12, against a rotating blade 14 mounted in projecting fashion upon a conventional table saw surface 16.

As is also conventionally known, a fence 18 is secured at a location upon the saw table, typically such that the saw blade 14 is disposed between the housing 10 and fence 18. Referring to FIG. 2, the fence 18 (Beistmeyer fence) can also be reconfigured as representatively shown at 18′ (regular fence), it being important to note that the fence defines a linearly extending abutment surface for the workpiece 12 and which opposes the substantially elongated and three-dimensional shaped unit which comprises the housing system.

As is further referenced in FIG. 1, the elongated unit defining the feed system 10 is secured in laterally adjustable fashion upon the table top surface 16, in the variant illustrated by a tightening screw 20 associated with at least one end location of the housing and projecting from an end bracket 22 overlapping a side edge 24 associated with the saw table. As will be further described, the screw 20 can be substituted by a hold-down cam handle or other suitable structure for securing the feed system upon the table top surface. The side edge 24 illustrated is typically a measurement and guide surface associated with the saw table and to facilitate correct positioning of the housing relative to the saw blade 14 and fence 18. Although not shown, an underside extending bracket associated with an opposite end of the housing biases against an opposite side edge of the saw table and in order to fix the assembly in place at a desired spaced location relative to the saw blade 14.

A cam surface supporting and extending lever is shown at 26, associated with an end of the fence 18, and which operates in cooperation with an opposite end and underside defined bracket, see in phantom at 28. Upon positioning the fence 18 a desired distance from the saw blade 14, such as which would approximate a width distance of the workpiece 12 abutting the housing 10 along an opposite edge, the cam lever 26 is rotated to clamp the fence to the table. It is also envisioned that the cam lever arrangement can be incorporated into a modification of the powered feed housing. Alternatively, the tightening screw arrangement can be utilized in a modification of a laterally adjustable fence or, in a further variant, the fence can be made fixed relative to the saw table with only the powered feed housing being adjustable.

A plurality of unidirectional rollers are illustrated at 30, 32, 34, et seq., and which are mounted at spaced locations along a linear distance associated with the three-dimensional feed housing, this typically including a metal or durable polymer shell 36. As illustrated in FIG. 1, the rollers 30, 32, 34, et seq. are each mounted for rotation about a vertical axis (see at 38 in FIG. 2) relative to an axis extending perpendicularly through the upper surface 16 of the saw table and such that outer annular edges 40 of each roller project through associated apertures (see at 42 in FIG. 2) defined in the side of the housing and biasingly contact against an associated side edge 44 of the workpiece 12.

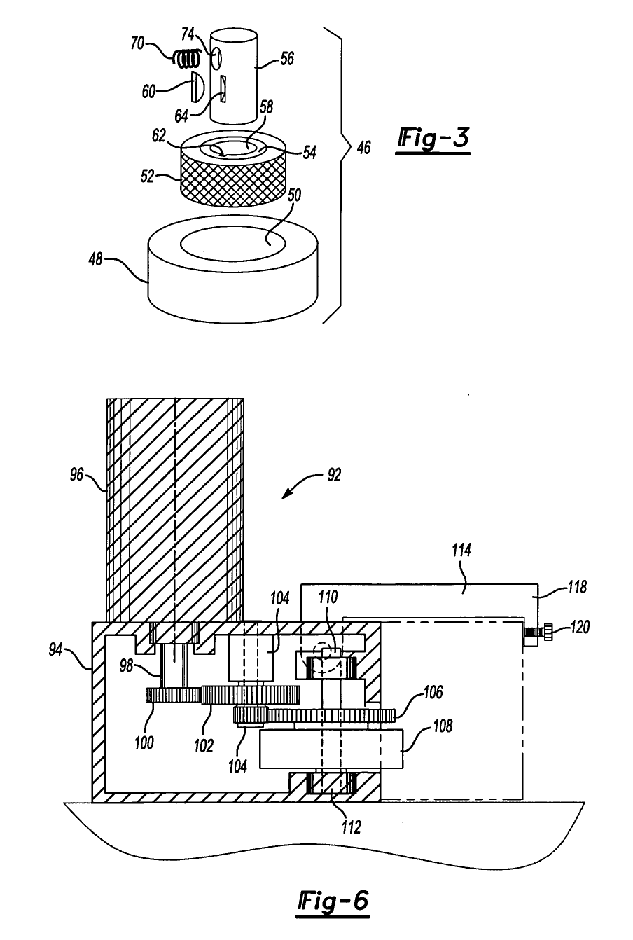

Referring again to each of FIGS. 2 and 3, a more detailed explanation of each of the unidirectional roller assemblies will now be provided. Selected roller, identified generally at 46 for purposes of FIG. 2 and FIG. 3, includes a rubberized outer (puck shaped) and annular shaped member 48, such including a durable and frictional surface, as well as a hollow central interior. It is also envisioned that the rubberized outer surface may be substituted by another frictional drive inducing surface, such being envisioned to include projecting metal spikes and the like.

A clutch assembly (see as best shown in FIG. 3) resistively seats within an open interior, see as referenced at 50, of the outer member 48. The clutch includes an outer and annular shaped race 52 exhibiting a knurled exterior surface and which immovably seats within the interior 50 of the outer member 48. An inner race 54 seats within an annular interior surface of the outer race 52 and such that the outer race is permitted to rotated in a selected (or unidirectional) fashion relative to the inner race. This is typically accomplished by the provision of a plurality of opposing rollers and ridge portions (see at 56 and 58 in phantom in FIG. 2) which are defined in opposing fashion between the outer and inner races. It is envisioned that any suitable modification of clutch mechanism can be employed within the scope of the invention and which will facilitate the desired one-way rotation of the outer race 52 relative to a fixed inner race 54.

A shaft 56 extends through a central aperture 58 defined in the inner race. A key ring 60 projects from the shaft 56 and engages a notch 62 defined in an annular surface associated with the key face inner face, the key ring 60 can further be mounted into an aperture 64 defined in the shaft 56.

As is also shown in reference to the cutaway of FIG. 2, the shaft 56 is supported between recessed interior top and bottom locations associated with the housing, see top and bottom side walls 66 and 68, and which are dimensioned such that the shaft 56 is permitted a degree of lateral offset. A spring 70, such as illustrated by a coil spring but capable of utilizing any type of extension spring, leaf spring or the like, biases between an inner side location 72 of the housing and a recessed location 74 associated with the shaft 56.

In this fashion, the shaft 56 is fixed in a non-rotating and biased manner in a direction towards the linearly fed workpiece. The outer race 52 and resistively mounted and rubberized outer member 48 rotate in unison about the shaft supported and fixed inner race 54 and in order that outer roller surface bias the workpiece in a unidirectional manner.

Referencing again the cutaway of FIG. 2, the outer annular edge 40 of the selected roller is elevated a slight distance above the surface of the table and to engage the side edge 44 of the workpiece, such as in this case being a ¾″ width board. It is further envisioned that additional variants of the invention can reposition each of the rollers in an abutting and contacting manner upon the surface of the table saw, such envisioning appropriate redesign of the shaft supporting structure.

Referring again to FIG. 1, a pair of hold down (vertical) attachment sub-assemblies are illustrated at 76 and 78, each of which securing to a lengthwise location of the feed system housing, see in particular hold-down clamps 80 and 82, respectively. Each of the hold down attachments includes a laterally adjustable stem, see at 84 and 86, upon an end of which is supported a downwardly extending roller, 88 and 90, respectively, for contacting an upper surface of the linearly fed workpiece 12 and maintaining the same in a hold-down position along an additional axis and as compared to the lateral hold down support of the workpiece established between the housing and the fence. It is further contemplated that the vertical hold down attachment units are capable of providing both up/down and in/out ranges of adjustability.

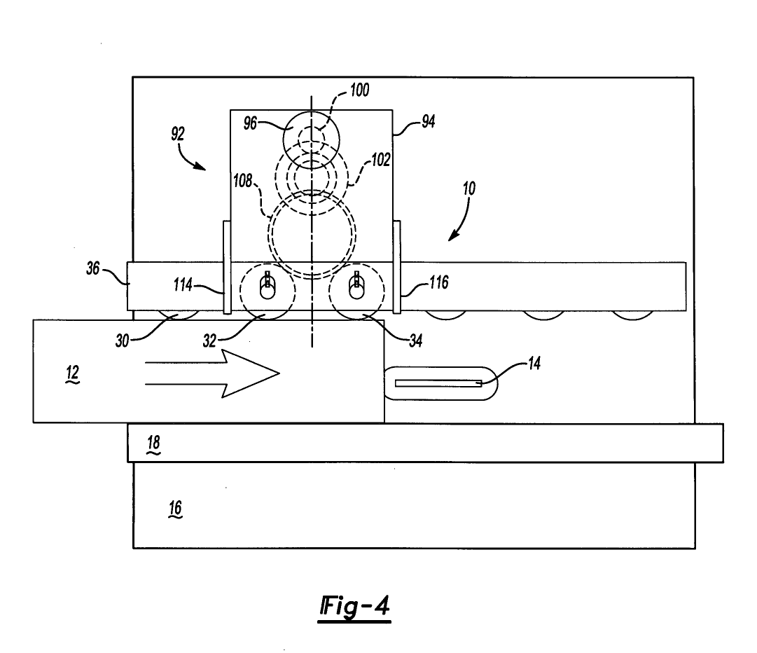

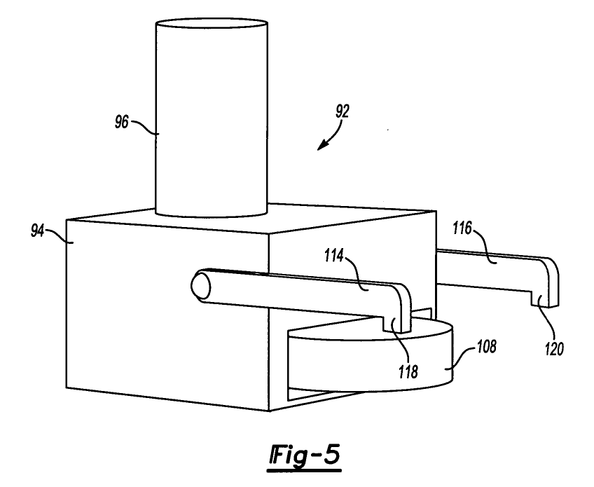

Referring now to FIG. 4, an overhead view is shown of a linear feed operation further incorporating a motor driven sub-assembly 92 (see as also generally shown in FIGS. 5 and 6), secured to the linear feed housing and operatively engaging one or more of its associated rollers. Specifically, the sub-assembly 92 includes a substantially square shaped housing 94, upon which is supported an electric motor 96 in upwardly extending fashion. It is also envisioned within the scope of the invention that, in order to improve user visibility, the motor can also be repositioned in a ninety-degree sideways extending fashion relative to the housing and through the use of a beveled gear arrangement.

As best illustrated in the cutaway illustration of FIG. 6, one preferred drive arrangement for providing powered operation of associated unidirectional rollers is illustrated and includes a downwardly extending drive shaft 98 associated with the motor and terminating in a rotating and annular shaped end support 100. The end support 100 is typically a first gear and which can be meshingly engaged with a further ratio defined gear 102 in turn rotatably supported at 104 to the housing 94.

A shaft 104 associated with the gear 102 supports a belt 106, this in turn engaging and driving a shaft supported rubberized roller 108 (see also laterally displaceable shaft support ends 110 and 112 in FIG. 6). As further shown in the overhead illustration of FIG. 4, the heavy duty and rubberized drive roller 108 in turn frictionally engaged a pair of unidirectional rollers, see at 32 and 34, and which are typically located in proximity to a feed side of the rotating saw blade 14.

In this fashion, the system provides an optional attachment for advancing the linearly fed workpiece 12 against the ripping motion of the saw blade 14, while maintaining the safety aspects of hold down and anti-kickback of the workpiece. It is also envisioned that, in order to decrease the size of the powered drive unit, a planetary gear arrangement can be substituted for the one illustrated without departing from the scope of the invention.

Also illustrated are a pair of support arms 114 and 116 extending in generally horizontal fashion from the housing 94, the arms each including a curled extending end, see at 118 and 120, respectively, for the purpose of supporting the sub-assembly 92 in position upon the system housing 10 and such that the gripping forces of the forward extending arms 114 and 116 (engaging the forward edge of the module housing) combined with the linear forces exerted between the drive roller 108 and unidirectional rollers 32 and 34, prevent inadvertent disengagement of the powered sub-assembly.

It is further envisioned that a suitable tightening screw (such as illustrated at 120 in FIG. 6) or the like can be incorporated into the support arms or other component of the powered sub-assembly and in order to maintain adequate support and location of the sub-assembly to the overall unit. It is also envisioned that the powered sub-assembly can be redesigned such that it is capable of driving any number of the unidirectional rollers within the scope of the invention. In a further variant, the support arms 114 and 116 associated with the power feed unit may be substituted for a substantially flattened and horizontal plate, which both supports the motor as well as establishes a terminating lip edge contacting a forward edge location of the housing.

Having described our invention, other and additional preferred embodiments will become apparent to those skilled in the art to which it pertains and without deviating from the scope of the appended claims.

I claim:

1. A system for advancing a workpiece in guided fashion towards a rotating blade associated with a saw table, a fence securing to the table a distance from the blade, said system comprising:
a housing secured upon the table such that the saw is disposed between said housing and fence, a width dimension associated with the workpiece generally corresponding to a distance between said housing and fence; and
a plurality of unidirectional rollers incorporated into said housing, each of said rollers exhibiting a vertical axis of rotation and having outer radial edges contacting associated side edges of the workpiece;
said unidirectional rollers facilitating linear feed of the workpiece against the blade, said housing and fence preventing kick-back of the workpiece resulting from a ripping operation performed by the blade.

2. The system as described in claim 1, said housing having a specified shape and size and comprising an elongated three-dimensional unit laterally adjustable upon the table in directions towards and away from the blade.

3. The system as described in claim 2, said rollers each mounting about an associated shaft secured at linearly spaced intervals along said housing, said outer radial edge associated with each roller projecting from an aperture defined in a side surface of said housing.

4. The system as described in claim 3, each of said rollers further comprising:
a friction holding outer member;
a clutch mounted coaxially within said outer member and comprising an outer race and unidirectional movement facilitating inner race; and
said shaft extending through said inner race, a key ring projecting from said shaft and engaging a notch defined in an annular surface associated with said inner face.

5. The system as described in claim 4, each of said rollers further comprising a biasing spring extending from said housing and engageable with said shaft to bias said roller against the workpiece.

6. The system as described in claim 5, further comprising a lateral spacing between each of said roller mounting shafts and supporting end locations associated with said housing.

7. The system as described in claim 2, further comprising a tightening screw associated with at least one end location of said housing and engageable with a side edge associated with the saw table.

8. The system as described in claim 2, further comprising a cam-actuated lever associated with an end location of at least one of said elongated housing and adjustable fence, an opposite end including an underside bracket biasing against an opposite edge of said table in response to actuation of said lever.

9. The system as described in claim 1, further comprising at least one hold down attachment secured said housing and supporting a roller in contact with an upper surface of the workpiece.

10. The system as described in claim 9, said hold down attachment further comprising a laterally adjustable and roller supporting stem.

11. The system as described in claim 2, further comprising a powered sub-assembly secured to a location associated with said housing and operatively driving at least one of said rollers to facilitate linear feed of said workpiece against the saw blade.

12. The system as described in claim 11, said sub-assembly further comprising a motor supporting housing, a drive shaft associated with said motor communicating with a drive roller via a belt drive.

13. The system as described in claim 12, further comprising said drive roller positioning in cooperating fashion with a selected pair of successive unidirectional rollers located proximate to a feed side of the saw blade.

14. The system as described in claim 11, said powered sub-assembly further comprising a pair of extending support arms engageable with specified locations associated with said housing.

15. A system for advancing a workpiece in guided fashion towards a rotating blade associated with a saw table, a fence securing to the table a distance from the blade, said system comprising:
a housing secured upon the table such that the saw is disposed between said housing and fence, said housing having a specified shape and size and comprising an elongated three-dimensional unit laterally adjustable upon the table in directions towards and away from the blade, a width dimension associated with the workpiece generally corresponding to a distance between said housing and fence; and
a plurality of unidirectional rollers incorporated into said housing, each of said rollers securing at linearly spaced intervals along said housing and each exhibiting a shaft supported and vertical axis of rotation such that an outer radial edge associated with each roller contacts an associated side edge of the workpiece;
said unidirectional rollers facilitating linear feed of the workpiece against the blade, said housing and fence preventing kick-back of the workpiece resulting from a ripping operation performed by the blade.

16. The system as described in claim 15, each of said rollers further comprising:
a rubberized outer member;
a clutch mounted coaxially within said outer member and comprising an outer race and unidirectional movement facilitating inner race; and
said shaft extending through said inner race, a key ring projecting from said shaft and engaging a notch defined in an annular surface associated with said inner face.

17. The system as described in claim 16, each of said rollers further comprising a biasing spring extending from said housing and engageable with said shaft to bias said roller against the workpiece.

18. The system as described in claim 17, further comprising a lateral spacing between each of said roller mounting shafts and supporting end locations associated with said housing.

19. The system as described in claim 15, further comprising at least one hold down attachment secured said housing and supporting a roller in contact with an upper surface of the workpiece, each of said hold down attachments further comprising a laterally adjustable and roller supporting stem.

20. The system as described in claim 15, further comprising a powered sub-assembly secured to a location associated with said housing and operatively driving at least one of said rollers to facilitate linear feed of said workpiece against the saw blade.
